(19) United States
(12) Patent Application Publication
(10) Pub. No.: US 2026/0264113 A1
(43) Pub. Date: Sep. 10, 2026

(54) METHOD FOR PROCESSING TARGET MATERIAL COMPRISING CLUMP-SHAPED COPPER WIRE SCRAPS

(71) Applicant: JX Advanced Metals Corporation, Tokyo (JP)

(72) Inventor: Katsushi AOKI, Kurobe-shi, Toyama (JP)

(73) Assignee: JX Advanced Metals Corporation, Tokyo (JP)

(21) Appl. No.: 19/127,243

(22) PCT Filed: Nov. 9, 2023
(86) PCT No.: PCT/JP2023/040449

§ 371 Date: May 12, 2026

(30) Foreign Application Priority Data
Dec. 20, 2022 (JP) 2022-203672

(51) Int. Cl. B07B 13/00; B03C 1/30; B07B 1/40; B07B 1/46; C22B 7/00; C22B 15/00

(52) U.S. Cl. CPC B07B 13/003; B03C 1/30; B07B 1/40; B07B 1/4609; C22B 7/005; C22B 15/0006

(57) ABSTRACT

There is provided a processing method that can suppress the accumulation of clump-shaped processing target material contained in a processing target material. A method for processing a processing target material includes rod-shaped processing target material and clump-shaped processing target material, the method including: sieving the processing target material using a vibrating sieve including a plurality of screens arranged along a conveying direction while conveying the processing target material; the method characterized in that, by the sieving, the clump-shaped processing target material included in the processing target material is collected on a top of the vibrating sieve.

### FIELD OF THE INVENTION

The present invention is related to a method for processing a processing target material that comprises lump-shaped copper wire scraps.

### BACKGROUND OF THE INVENTION

In recent years, from the viewpoint of resource conservation, recovery of valuable metals from parts scraps of electronic/electrical devices such as discarded home appliances and PCs and mobile phones has become increasingly common, and efficient methods for recovering such metals have been studied and proposed.

For example, Japanese Patent Application Publication No. H09-78151 (Patent Literature 1) discloses a method for recycling valuable metals from scraps, in which scraps containing valuable metals is charged from the ceiling of a shaft into a flash smelting furnace for smelting copper ore, and the valuable metals are recovered into matte remaining in the furnace. According to the configuration of Patent Literature 1, copper smelting in a copper flash smelting furnace is combined with scrap processing, so valuable metals can be recovered at low cost even from scrap with a low valuable metal content.

It has also been proposed to crush the scrap electronic/electrical equipment parts to reduce their volume before processing them in a copper flash smelting furnace. For example, Japanese Patent Application Publication No. 2015-123418 (Patent Literature 2) describes a method of incinerating electronic/electrical device parts scraps containing copper, pulverizing to a predetermined size or smaller, and processing the pulverized electronic/electrical device parts scraps in a copper smelting furnace.

Moreover, coated copper wire scraps are known as one type of electronic/electrical device scraps containing copper. Such coated copper wire scraps were recycled if their shapes were stable and in good condition, while materials that were difficult to process were exported overseas as valuable materials. However, in recent years, coated copper wire scraps which are difficult to process have been accumulating in Japan, and there has been a demand for the proposal of a new method for efficiently processing such coated copper wire scraps which are difficult to process and recovering valuable materials.

Japanese Patent Application Publication No. 2010-236718 (Patent Literature 3) discloses a method for operating a gasification and melting furnace, in which industrial waste is fed into a fluidized bed gasification furnace, and a fluidized bed is formed by blowing air into the gasification furnace from below, thereby gasifying a portion of the industrial waste by pyrolysis and recovering non-combustible materials including valuable metals, and the pyrolysis gas produced in the gasification furnace and a portion of the non-combustible materials transported by the pyrolysis gas are processed in a melting furnace to produce slag, the method characterized in that a calcium-containing dust is made into a slurry and then injected into the melting furnace.

As a facility for melting and processing industrial waste that contains metals such as aluminum, iron, copper, zinc, and lead, and polyvinyl chloride, which serves as a chlorine source, such as automobile shredder residue (hereinafter also referred to as “ASR”) and home appliance shredder residue, there is known an industrial waste melting and processing facility equipped with a fluidized bed gasification furnace, such as the melting and processing facility disclosed in Japanese Patent Application Publication No. H11-302748 (Patent Literature 4).

The fluidized bed gasification furnace disclosed in Patent Literature 3 is intended to recover valuable metals contained in the above-mentioned industrial waste.

### PRIOR ART

### Patent Literature

[Patent Literature 1] Japanese Patent Application Publication No. H09-78151

[Patent Literature 2] Japanese Patent Application Publication No. 2015-123418

[Patent Literature 3] Japanese Patent Application Publication No. 2010-236718

[Patent Literature 4] Japanese Patent Application Publication No. H11-302748

### SUMMARY OF THE INVENTION

### Problem to be Solved by the Invention

In a fluidized bed gasification furnace, a granular material called “sand” that serves as a heat transfer medium is fed into a heat transfer medium inlet located at the top, and a fluidized bed is formed by air blown upward from air outlets at the bottom of the furnace. Then, the sand, which serves as a heat transfer medium, is discharged from the furnace through a discharge chute extending downward from the bottom of the furnace together with the non-combustible waste material (hereinafter referred to as “gasification furnace metals”) that was added from above the bottom of the furnace. the discharged gasification furnace metals and sand are sieved by a sieving machine, and the sand is fed back into the furnace from above the bottom through a circulation passage. Meanwhile, the gasification furnace metals are separated by a magnetic separator into large iron scraps (gasification furnace ferrous metals) and the rest (gasification furnace non-ferrous metals), and the gasification furnace non-ferrous metals are further separated by sieving into gasification furnace fine scrap, which contains copper and precious metals that fall below the sieve, and gasification furnace mixed metals, which contains stainless steel scraps and aluminum scraps that stay above the top of the sieve. In addition, the sand is crushed using a crusher, and the fine iron is collected as iron sand using a magnetic separator.

The gasification furnace non-ferrous metals after the magnetic separation contain aluminum scraps as well as stainless steel scraps. Since stainless steel scraps and aluminum scraps contain a large amount of Cr, Ni, and Al, which are components that inhibit copper smelting, it is desirable to remove them before feeding them into the copper smelting process. Compared with gasification furnace fine scrap, stainless steel scraps and aluminum scraps contain a large number of relatively large pieces in the raw material, and therefore are difficult to reduce in size when crushed. Therefore, it is possible to screen the particles using, for example, openings of a punched metal. This is because it is believed that stainless steel scraps and aluminum scraps will remain above the top of the sieve, while other fine parts scraps containing copper and precious metals, which are abundant in the gasification furnace fine scrap, and sand, will fall below the sieve. This allows the stainless steel scraps, aluminum scraps, and the like, from which the sand has been removed, to be separated and collected. In addition, the copper flash smelting furnace can accept gasification furnace fine scrap mixed with sand.

Here, copper contained in the gasification furnace fine scrap is often collected as copper wire scraps. Such copper wire scraps include thin, linear-shaped copper wire scraps, and clump-shaped copper wire scraps that are entangled with each other and have a steel wool-like shape. Once this clump-shaped copper wire scraps gets caught in the sieve and remains there, it continues to tangle with other processing target material, clogging the mesh and reducing the accuracy of separation, so it was necessary to interrupt the sieving process and remove it. Therefore, in order to reduce interruptions to processing and improve productivity, a means for efficiently separating clump-shaped copper wire scraps was needed. Furthermore, while the above is an example relating to copper wire scraps, separation issues such as these exist for any processing target material that includes clump-shaped wire scraps, not limited to only copper wire scraps.

The present invention was completed in consideration of the above-mentioned problems, and in one embodiment, an object of the present invention is to provide a processing method that can suppress the accumulation of clump-shaped processing target material, particularly clump-shaped wire scraps, contained in the processing target material. In a preferred embodiment of the present invention, an object of the present invention is to provide a processing method capable of suppressing the accumulation of clump-shaped copper wire scraps, which is one form of clump-shaped wire scraps.

### Means for Solving the Problem

As a result of extensive research, the present inventor has noticed that the shape of the processing target material affects the retention of clump-shaped wire scraps. Specifically, there are four types of processing target material: linear-shaped, plate-shaped, rod-shaped, and clump-shaped. However, when screening using openings of a punched metal or the like, it has been found that the processing target material is caught in the openings and become accumulated. In particular, if lump-shaped or rod-shaped processing target materials are caught in the openings, they can cause other processing target materials to be caught as well.

Accordingly, in order to eliminate the cause of the accumulation of clump-shaped processing target material, the present inventor focused on employing a sieve having a structure that makes it difficult for the clump-shaped processing target material to become caught. However, when rod-shaped processing target material is contained in addition to the clump-shaped processing target material, the rod-shaped processing target material may stand vertically or at an angle to the openings, causing the clump-shaped processing target material to be caught.

Therefore, as will be described below, it was discovered that by making the length of a flat portion of a sieve where no openings are present longer than in prior arts, and further setting the gaps between the comb-tooth-shaped portion and the flat portion of two adjacent screens within a certain range, it is possible to effectively suppress the accumulation of clump-shaped processing target material caused by rod-shaped processing target material. The present invention has been completed based on the above findings, and is exemplified as below.
[1]

A method for processing a processing target material comprising rod-shaped processing target material and clump-shaped processing target material, the method comprising:
sieving the processing target material using a vibrating sieve comprising a plurality of screens arranged along a conveying direction while conveying the processing target material;
wherein each screen comprises a plate-shaped flat portion and a comb-tooth-shaped portion,
wherein, except for the screen located at the most downstream side in the conveying direction, the comb-tooth-shaped portion of each screen overlaps with a part of the flat portion of an adjacent screen located downstream in the conveying direction to form a plurality of openings,
wherein assuming a diameter of the plurality of openings is D and a length of the flat portion in the conveying direction is L₁, a relationship of 2×D≤L₁≤10×D is satisfied,
wherein assuming a gap between the comb-tooth-shaped portion and the flat portion of each of two screens forming the plurality of openings is H, a relationship of 0.2×D≤H≤0.5×D is satisfied,
the method characterized in that, by the sieving, the clump-shaped processing target material comprised in the processing target material is collected above a top of the vibrating sieve.
[2]

The method according to [1], wherein the diameter D of the plurality of openings is 8 to 20 mm.
[3]

The method according to [1] or [2], wherein each screen further comprises a skirt portion extending from the flat portion and downwardly from the plurality of openings, and
assuming a length of the skirt portion is L₂, a relationship 1×D≤L₂≤5×D is satisfied.
[4]

The method according to any one of [1] to [3], wherein the plurality of openings is horseshoe-shaped, trapezoidal, rectangular, or triangular.
[5]

The method according to any one of [1] to [4], wherein the processing target material further comprises a rod-shaped and/or plate-shaped processing target material, and the method further comprises, after the sieving, sieving the processing target material above the top of the vibrating sieve using a comb-tooth-shaped vibrating sieve comprising a plurality of slits.
[6]

The method according to [5], wherein an interval L₃ between the plurality of slits is 50 to 150 mm.
[7]

The method according to any one of claims [1] to [6], wherein a raw material of the processing target material comprises automobile shredder dust, home appliance shredder dust, or electronic/electrical device part scraps.
[8]

The method according to [5] or [6], wherein the processing target material comprises stainless steel scraps and/or aluminum scraps, and the method comprises recovering the stainless steel scraps and/or the aluminum scraps by sieving using the comb-tooth-shaped vibrating sieve comprising the plurality of slits.
[9]

The method according to any one of [1] to [8], wherein the processing target material is obtained by processing automobile shredder dust, home appliance shredder dust, and crushed electronic and electrical device parts scraps in a gasification and melting furnace to remove combustible components such as resins, and then removing magnetic substances by magnetic separation or the like.
[10]

The method according to [9], wherein the processing in the gasification and melting furnace is carried out under conditions of an air ratio of 1 or less and a temperature of 400 to 600° C.
[11]

The method according to any one of [1] to [10], wherein the clump-shaped processing target material comprises a clump-shaped wire scraps formed by entanglement of wire scraps.
[12]

The method according to any one of [1] to [11], wherein the clump-shaped processing target material comprises clump-shaped copper wire scraps formed by entanglement of copper wire scraps.

### Effect of the Invention

According to the present invention, it is possible to provide a processing method capable of suppressing accumulation of clump-shaped processing target material contained in a processing target material.

### BRIEF DESCRIPTION OF THE DRAWINGS

FIG. 1 is a schematic diagram of the configuration of a vibrating sieve in one embodiment of the present invention. FIG. 1A is a top view, and FIG. 1B is a side view.

FIG. 2 is a schematic diagram of the configuration of a comb-tooth-shaped vibrating sieve comprising a plurality of slits according to one embodiment of the present invention.

### DETAILED DESCRIPTION OF THE INVENTION

Hereinafter, embodiments of the present invention will now be described in detail. It should be understood that the present invention is not intended to be limited to the following embodiments, and any change, improvement or the like of the design may be appropriately added based on ordinary knowledge of those skilled in the art without departing from the spirit of the present invention.

### 1. Processing Target Material

The processing target material comprises rod-shaped and clump-Shaped processing target material. In addition, various processing target materials, including those having a linear or plate shape, can be used as the processing target material. The processing target material with each shape is anticipated to be a metallic material, but the specific composition is not limited. In the present embodiment, the clump-shaped processing target material includes clump-shaped wire scraps, and in particular will be described as clump-shaped copper wire scraps. In addition, in the present embodiment, a processing target material derived from ASR, home appliance shredder dust, or electronic/electrical device parts scraps will be described. ASR, home appliance shredder dust, and electronic/electrical device parts scraps can be appropriately crushed and sorted, and then processed in a gasification and melting furnace or the like to remove combustible components such as resins, and then magnetic materials such as iron scraps can be removed by magnetic sorting or the like. In addition, since automobiles and home appliances usually contain electronic/electrical equipment, ASR and home appliance shredder dust may also contain electronic/electrical device parts scraps. In addition, since the shapes of the processing target material are diverse, there are no strict standards for the rod-shaped and clump-shaped shapes as mentioned above. In general, however, it can be considered that rod-shaped objects are hard and difficult to bend, and have an aspect ratio (the ratio of the longest diameter to the shortest diameter measured in three dimensions) of 3 or more, while clump-shaped objects have an aspect ratio of less than 3.

The processing target material from which the magnetic substances have been removed may contain stainless steel scraps and/or aluminum scraps that cannot be completely removed by magnetic separation, and these scraps contain any of Cr, Ni, or Al, which are copper smelting inhibitors. As described below, in some embodiments of the present invention, it is possible to separate stainless steel scraps and/or aluminum scraps by sieving using a comb-tooth-shaped vibrating sieve comprising a plurality of slits.

In addition, a gasification and melting furnace usually has a reducing atmosphere, which thermally decomposes and gasifies waste plastics such as resin while preventing rapid combustion of combustible materials. In this case, it is expected that the oxidation of metals such as copper, iron, stainless steel, and aluminum can be prevented in an internal circulation type fluidized bed gasification furnace. Therefore, it is expected that the separated stainless steel scraps and/or aluminum scraps are recovered in a state in which oxidation is suppressed. Since the stainless steel scraps and/or aluminum scraps in a state in which oxidation is suppressed are easy to process, the Fe and Al elements contained therein are easily reused.

In this way, it is expected that a gasification and melting furnace can suppress oxidation due to its reducing atmosphere, but a similar effect can be expected from any furnace that can perform a processing in a reducing atmosphere. Therefore, the processing furnace for gasifying ASR, home appliance shredder dust, and electronic and electrical device parts scraps after appropriate crushing and sorting can be any furnace that has a reducing atmosphere, and is not limited to a gasification and melting furnace. The type of reducing atmosphere is not limited, and may be, for example, hydrogen (H₂), carbon monoxide (CO), or a hydrocarbon gas (CH₄, C₃H₈, C₄H₁₀, and the like). Alternatively, by setting the air ratio (the ratio between the amount of air theoretically required to completely combust the fuel (theoretical air amount) and the amount of air actually sent in for combustion) during gasification to 1 or less, combustible materials such as ASR and home appliance shredder dust are partially combusted and thermally decomposed into combustible gas and ash, so that a strongly reducing atmosphere can be created inside the gasification furnace.

The temperature for the gasification processing is not particularly limited, but since the melting point of aluminum is 660° C., it is preferable to set the temperature to 600° C. or lower. This makes it easier to suppress oxidation of the stainless steel scraps and/or aluminum scraps. However, since the gasification of resin components such as LDPE, HDPE, and PE is usually completed at 400° C. or higher, the gasification temperature is preferably 400° C. or higher in order to achieve the purpose of the gasification processing.

Therefore, in one embodiment of the present invention, the processing target material is that has undergone a gasification processing with an air ratio of 1 or less and at a temperature of 400 to 600° C.

Furthermore, the processing target material may contain valuable metals such as gold, silver, platinum, and palladium in addition to copper.

Therefore, in one embodiment of the present invention, the processing target material includes rod-shaped and clump-shaped processing target materials, as well as linear-shaped and plate-shaped processing target materials. The clump-shaped processing target materials may include a clump-shaped wire scrap formed by entanglement of wire scraps such as copper wire scraps. Then, as described below, by sieving using a vibrating sieve having a plurality of screens, the clump-shaped processing target material is sieved above the top of the sieve, and the other linear, rod-shaped, and plate-shaped processing target materials are sieved above the top of or below the sieve depending on the diameter of the sieve. When the processing target material contains stainless steel scraps and/or aluminum scraps, the raw material contains a large number of relatively large pieces, and therefore it is difficult to reduce the size of the pieces when crushed. Therefore, the stainless steel scraps and aluminum scraps are sieved above the top of the sieve together with the clump-shaped processing target material. In this manner, when the processing target material that remains above the top of the sieve contains stainless steel scraps and/or aluminum scraps, the material can be further sieved using a comb-tooth-shaped vibrating sieve having a plurality of slits to separate the material into the clump-shaped processing target material that remains above the top of the sieve and stainless steel scraps and/or aluminum scraps that falls below the sieve. In addition, since complete separation of each component is impossible in sieving using a vibrating sieve, in this specification, sieving of each component does not necessarily mean complete separation.

### 2. Separation of Clump-Shaped Processing Target Material

As an embodiment of the clump-shaped processing target material, clump-shaped wire scraps, in particular clump-shaped copper wire scraps, will be described. Copper wire scraps include thin, linear-shaped copper wire scraps, and clump-shaped copper wire scraps that are entangled with each other and have a steel wool-like shape. Clump-shaped copper wire scraps are generally generated from rolling up linear pieces having a diameter of about 0.05 to 0.5 mm into a clump, and the overall diameter of the clump-shaped copper wire scraps is greater than the opening size of a normal sieve and can reach a maximum of about 500 mm. Therefore, if the processing target material is sieved using a typical sieve with multiple openings (for example, a punched metal), the clump-shaped copper wire scraps will get caught in the openings of the sieve and become retained there, and will in turn become entangled with other processing target material, making it necessary to interrupt the sieving process and remove the scraps.

As described above, this phenomenon occurs when rod-shaped processing target material get caught in the openings of the sieve and rise up vertically or obliquely. Such rod-shaped processing target material is typically a metal wire with a diameter of about 0.5 to 2 mm and about 50 to 200 mm in length that is bent three-dimensionally, and the short diameter of the three-dimensional shape can be about 25 to 100 mm. Therefore, if the rod-shaped processing target material do not enter the openings in the sieve, they will not get caught in the openings, so it is possible to adopt a structure that makes it difficult for the rod-shaped processing target material to enter the openings in the sieve. In addition, it is also believed that this phenomenon can be improved by using a sieve with a structure that makes it difficult for rod-shaped processing target material to get caught. In the present embodiment, the processing target material is sieved using a specific vibrating sieve having a plurality of screens, so that the clump-shaped processing target material can be effectively prevented from remaining and separated.

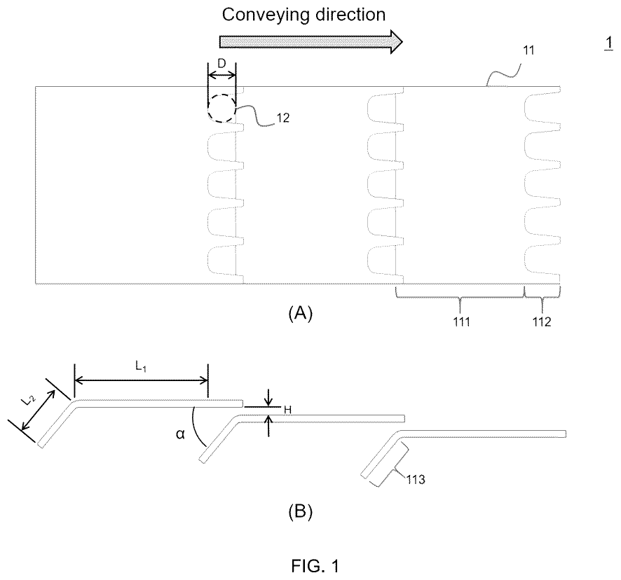

FIG. 1 is a schematic diagram showing the configuration of a vibrating sieve 1 having a plurality of screens 11 according to an embodiment of the present invention. The screen 11 has a plate-shaped flat portion 111 and a comb-tooth-shaped portion 112. The plate-shaped flat portion 111 is disposed horizontally, and the teeth of the comb-tooth-shaped portion 112 are arranged in a direction substantially perpendicular to the conveying direction of the processing target material and extend horizontally. In addition, in FIG. 1, three screens 11 are shown, but the number of screens 11 is not limited to this. Furthermore, in each screen 11, the number of comb teeth of the comb-tooth-shaped portion 112 does not need to be limited to the number shown in the figure.

For the plurality of the screens 11, except for the screen 11 located at the most downstream side in the conveying direction, the comb-tooth-shaped portion 112 of each screen 11 overlaps with a portion of the flat portion 111 of the adjacent screen 11 located downstream in the conveying direction, thereby forming a plurality of openings 12. Here, the overlap means that, as viewed from above, the comb-tooth-shaped portion 112 of one screen 11 appears to overlap the flat portion of the other screen 11. This overlap forms the openings 12.

In addition, Although the openings 12 appear to be closed shapes as viewed from above, the comb-tooth-shaped portion 112 of one screen 11 and the flat portion of the other screen 11 are not actually in contact with each other (see FIG. 1B).

In the present embodiment, assuming the length of the flat portion 111 in the conveying direction is L₁ and the diameter of the opening 12 is D, it is important to satisfy a relationship 2×D≤L₁≤10×D. The reason why rod-shaped processing target material become retained in the openings of the sieve is thought to be that the center of gravity of the processing target material changes during the screening process, causing the ends of the processing target material to stand up, making them easier to become retained in the openings of the sieve. However, if the length L₁ of the flat portion 111 is 2×D or more, the change in the center of gravity of the rod-shaped processing target material is small, and the rod-shaped processing target material is less likely to enter the openings of the sieve. From this viewpoint, L₁ is preferably 3×D or more, more preferably 4×D or more, and even more preferably 5×D or more.

On the other hand, if L₁ is more than 10×D, the effect reaches a plateau, and in order to ensure the length of the flat portion 111, it is necessary to enlarge the entire device, resulting in increased costs. Therefore, the upper limit of L₁ is set to 10×D. The upper limit of L₁ is preferably 9×D or less, more preferably 8×D or less, and even more preferably 7×D or less.

It should be noted that the length L₁ of the flat portion 111 in the conveying direction refers to the distance from the upstream end of the flat portion 111 to the upstream end of the comb-tooth-shaped portion 112 in the conveying direction (FIG. 1). If the distance is not constant, the minimum value is measured and used as the length L₁ of the flat portion 111 in the present embodiment.

Further, in the present embodiment, assuming the diameter of the openings 12 is D and the gap between the comb-tooth-shaped portion 112 and the flat portion 111 of each of two screens 11 that form the plurality of openings 12 is H, it is important to satisfy a relationship of 0.2×D≤H≤0.5×D. By setting H to 0.2×D or more, the rod-shaped processing target material is less likely to get caught even when they enter the openings 12, and as a result, the clump-shaped processing target material is less likely to become retained. From this viewpoint, H is preferably 0.25×D or more, and more preferably 0.3×D or more.

On the other hand, if H is more than 0.5×D, the rod-shaped processing target material is likely to stand up when entering the openings 12, so the upper limit of H is set to 0.5×D. The upper limit of H is preferably 0.45×D or less, more preferably 0.4×D or less, and even more preferably 0.35×D or less.

It should be noted that the diameter D of the openings 12 refers to the diameter of the maximum inscribed circle of the openings 12 as viewed from above. The gap H between the comb-tooth-shaped portion 112 and the flat portions 111 of each of two adjacent screens 11 refers to the vertical distance between the comb-tooth-shaped portion 112 of the upstream screen 11 and the flat portion 111 of the downstream screen 11, excluding the thickness of the comb-tooth-shaped portion 112 of the upstream screen 11 (FIG. 1). In addition, when the vertical distance is not constant, the minimum value is measured and used as the gap H in the present embodiment. Further, the thickness of the comb-tooth-shaped portion 112 of the screen 11 on the upstream side is not particularly limited, and it is sufficient that the thickness provides enough strength to withstand the weight of the processing target material.

The shape of the openings 12 is not particularly limited, but may be horseshoe-shaped, trapezoidal, rectangular, or triangular. The shape of the openings 12 here refers to a shape surrounded by the outline of the comb-tooth-shaped portion 112 of one screen 11 and the flat portion 111 of the adjacent screen 11 located downstream in the conveying direction, as viewed from above. When the contour line of the flat portion 111 is taken as the base of the shape, the base is typically a straight line. Here, the horseshoe shape refers to the side other than the base side (that is, the contour line formed by the comb-tooth-shaped portion 112) being an arch-shaped curve. When the shape of the openings 12 is a trapezoid, a rectangle, or a triangle, the shape of the comb-tooth-shaped portion 112 may be formed so that these have chamfered shapes.

In addition, as described above, the shape of the openings 12 means a projected shape as viewed from above, because there is a gap H between the comb-tooth-shaped portion 112 and the flat portions 111 of each of two adjacent screens 11. The diameter D of the openings 12 is calculated based on the projected shape as viewed from above.

The diameter D of the openings 12 is preferably 8 to 20 mm. If it is 8 mm or more, the linear-shaped processing target material can easily fall through the sieve. From this viewpoint, the diameter D of the opening 12 is more preferably 8 mm or more. If it is 20 mm or less, the clump-shaped processing target material can be collected more efficiently. From this viewpoint, the diameter D of the openings 12 is more preferably 15 mm or less.

In a preferred embodiment of the present invention, each screen 11 further comprises a skirt portion 113 extending from the flat portion 111 downwardly from the plurality of openings 12, and assuming the length of the skirt portion 113 is L₂, it is preferable that a relationship 1×D≤L₂≤5×D is satisfied (FIG. 1B).

By providing the skirt portion 113 and setting its length L₂ to 1×D or more, the rod-shaped processing target material is less likely to get caught even when they enter the openings 12, and as a result, the clump-shaped processing target material is less likely to become retained. On the other hand, if L₂ is greater than 5×D, the effect reaches a plateau and the device becomes excessively heavy, so the upper limit of L₂ is set to 5×D. The upper limit of L₂ is preferably 5×D or less, more preferably 4×D or less, and even more preferably 3×D or less.

It should be noted that the length L₂ of the skirt portion 113 refers to the distance from the upstream end of the skirt portion 113 to the upstream end of the flat portion 111 (FIG. 1B). If this distance is not constant, the minimum value is measured and used as the length L₂ of the skirt portion 113 in the present embodiment.

The angle a between the skirt portion 113 and the extension line of the flat portion 111 is not particularly limited, but is preferably 10° or more from the viewpoint of suppressing the rod-shaped processing target material from getting caught. The upper limit of the angle a is not particularly limited, but is typically 90° or less.

In order to sieve the processing target material, it is necessary to vibrate the vibrating sieve 1 during the implementation of the method of this embodiment. The structure for vibrating the sieve may be a known one, and detailed description of the structure etc. will be omitted.

The above-mentioned treatment prevents the rod-shaped processing target material from getting caught, which is a cause of the clump-shaped processing target material being retained, so that the object of the present invention is achieved.

In addition, when gasification furnace non-ferrous metals are used as the raw material, the processing target material that falls from the vibrating sieve 1 contains little stainless steel scraps and/or aluminum scraps and a lot of copper and precious metals that contain few copper smelting inhibitors, so it can be input into copper smelting.

When gasification furnace non-ferrous metals are used as the raw material, the processing target material after separation of stainless steel scraps and/or aluminum scraps mainly contains copper and precious metals as well as sand. However, since a copper flash smelting furnace can accept sand contamination, it is possible to input the material into the copper smelting process.

### 3. Separation of Rod-Shaped or Plate-Shaped Processing Target Material

As a result of sieving by the vibrating sieve 1, the processing target material including clump-shaped processing target material remain above the top of the sieve, and linear-shaped processing target material falls below the sieve. The processing target material above the top of the sieve also includes rod-shaped and/or plate-shaped processing target materials sieved according to their size. These rod-shaped and/or the plate-shaped processing target materials contain a high content of stainless steel scraps and/or aluminum scraps.

In order to collect the clump-shaped processing target material, in particular, clump-shaped copper wire scraps which contain copper, from the processing target material that remains above the top of the sieve and input them into a copper smelting process, it is necessary to remove the rod-shaped and/or the plate-shaped processing target material. Therefore, by sieving using a comb-tooth-shaped vibrating sieve having a plurality of slits, the rod-shaped and/or the plate-shaped processing target material can be separated.

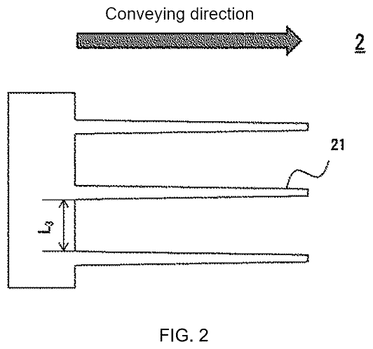

FIG. 2 is a schematic diagram (top view) showing the configuration of a comb-tooth-shaped vibrating sieve 2 having a plurality of slits 21 according to an embodiment of the present invention. In the present embodiment, the plurality of slits 21 are arranged in parallel and have a tapered shape, but their longitudinal direction is oriented parallel to the conveying direction of the processing target material. The cross-sectional shape of the plurality of slits 21 in a direction perpendicular to the longitudinal direction is not particularly limited, and may be any shape including a rectangle, a trapezoid, a circle, or a semicircle. The interval L₃ between the plurality of slits 21 is preferably 50 to 150 mm. If it is 50 mm or more, the plate-shaped processing target material can easily fall through the sieve. From this viewpoint, it is more preferable that the interval L₃ between the plurality of slits 21 is equal to or greater than 50 mm. If the length is 150 mm or less, the clump-shaped copper wire scraps can be collected more efficiently. From this viewpoint, the interval L₃ between the plurality of slits 21 is not particularly limited, but is more preferably 150 mm or less. When the interval L₃ between the plurality of slits 21 is not constant, the minimum interval in the direction perpendicular to the conveying direction in the above top view is set as the interval L₃ between the plurality of slits 21.

The length of the plurality of slits 21 can be appropriately set depending on the transport speed of the objects to be processed, the required separation accuracy, and the like, and can be, for example, 100 to 300 mm. In addition, if the length of the plurality of slits 21 is sufficient, there is no need to connect the ends of the slits together, and they may be open as shown in FIG. 2. Further, when the tips of the plurality slits 21 are open, the thickness can be increased in order to maintain strength, or a reinforcing mechanism can be provided below (not shown in figures).

Further, the comb-tooth-shaped vibrating sieve 2 having a plurality of slits 21 may be disposed immediately downstream of the vibrating sieve 1 having a plurality of screens 11. This allows the processing target material to be processed in one continuous process.

The processing target material from which the rod-shaped and/or the plate-shaped processing target materials have been separated can be used as a clump-shaped processing target material, in particular, as clump-shaped copper wire scraps containing copper, and can be input into a copper smelting process.

In addition, the separated stainless steel scraps and aluminum scraps can be separated and collected in a state where oxidation is suppressed due to the reducing atmosphere in gasification process.

### EXAMPLES

Hereinafter, the present invention will be specifically described below with reference to the Examples. However, the description here is for the purpose of illustration only and is not intended to be limiting.

### Example

As the processing target material, ASR and home appliance shredder dust, were processed in a fluidized bed gasification furnace to gasify the contained waste plastics, and the processing target material after magnetic separation (gasification furnace non-ferrous metals) were treated using a vibrating sieve 1 shown in FIG. 1. The vibrating sieve 1 had 16 screens 11, and each screen 11 had a flat portion with a length L₁ of 75 mm, a skirt portion 113 with a length L₂ of 25 mm, and an angle a of 50°. The screens 11 were arranged so that the gap H between the comb-tooth-shaped portion 112 and the flat portion 111 of each of two screens 11 forming the openings 12 was 4 mm, and the diameter D of the opening 12 was 12 mm. In this Example, the shape of the opening 12 was horseshoe-shaped.

When about 10 kg of the processing target material was processed, all of the clump-shaped copper wire scraps were collected on the top of the vibrating sieve 1, and all of the linear-shaped processing target material fell, with no residue remaining on the vibrating sieve 1.

Next, the processing target material collected on the top of the vibrating sieve 1 was processed by a vibrating sieve 2 shown in FIG. 2. The plurality of slits 21 were parallel to each other and spaced apart from each other by 80 to 120 mm. By the treatment with the vibrating sieve 2, all of the clump-shaped copper wire scraps were collected on the top of the vibrating sieve 2, and all of the rod-shaped and/or the plate-shaped processing target material fell, with no residue remaining on the vibrating sieve 2.

In addition, for the vibrating sieve 1, the composition of the processing target material remained above the top of the sieve and the processing target material fell below the sieve were analyzed by ICP-OES after alkali fusion to evaluate the separation rate. Specifically, since the processing target material other than stainless steel scrap contain almost no Cr (usually 0.5% by weight or less), the total weight of Cr above the top of sieve and below the sieve was taken as 100%, and the ratio of the Cr weight above the top of the sieve was used as the separation rate of stainless steel scrap. On the other hand, since the processing target material other than the aluminum scraps contained almost no Al, the total weight of the Al above the top of the sieve and below the sieve was taken as 100%, and the ratio of the Al weight above the top of the sieve was used as the separation rate of the aluminum scraps. As a result, the separation rates of the stainless steel scraps and the aluminum scraps were 90% or more and 40% or more, respectively.

In addition, when the cut fracture surfaces of the recovered stainless steel scraps and aluminum scraps were visually inspected, it was found that the fracture surfaces had a metallic luster and were in a state where they were hardly oxidized. In addition, the Fe and Al elements do not become alloy metals and can be recovered as valuable metals.

### Comparative Example

The processing target material was the same as in the Example, and the vibrating sieve had 16 screens 11, each of which had a flat portion length L₁ of 20 mm, a skirt portion 113 length L₂ of 50 mm, and an angle a of 37°. The gap H between the comb-tooth-shaped portion 112 and the flat portions 111 of each of two screens 11 forming the openings 12 was 2 mm, and the diameter D of the openings 12 was 18 mm. In this Comparative Example, the shape of the openings 12 was horseshoe-shaped.

As a result of the Comparative Example, a phenomenon occurred in which some of the rod-shaped processing target material got caught in the overlapping portion of the gap H, and clump-shaped copper wire scraps got caught thereon.

### DESCRIPTION OF REFERENCE NUMERALS

1 Vibrating sieve comprising a plurality of screens
11 Screen
111 Flat portion
112 Comb-tooth-shaped portion
113 Skirt portion
12 Openings
2 Comb-shaped vibrating sieve comprising a plurality of slits
21 Slits

1. A method for processing a processing target material comprising rod-shaped processing target material and clump-shaped processing target material, the method comprising:
sieving the processing target material using a vibrating sieve comprising a plurality of screens arranged along a conveying direction while conveying the processing target material;
wherein each screen comprises a plate-shaped flat portion and a comb-tooth-shaped portion,
wherein, except for the screen located at the most downstream side in the conveying direction, the comb-tooth-shaped portion of each screen overlaps with a part of the flat portion of an adjacent screen located downstream in the conveying direction to form a plurality of openings,
wherein assuming a diameter of the plurality of openings is D and a length of the flat portion in the conveying direction is L₁, a relationship of 2×D≤L₁≤10×D is satisfied, wherein assuming a gap between the comb-tooth-shaped portion and the flat portion of each of two screens forming the plurality of openings is H, a relationship of 0.2×D≤H≤0.5×D is satisfied,
the method characterized in that, by the sieving, the clump-shaped processing target material comprised in the processing target material is collected above a top of the vibrating sieve.

2. The method according to claim 1, wherein the diameter D of the plurality of openings is 8 to 20 mm.

3. The method according to claim 1, wherein each screen further comprises a skirt portion extending from the flat portion and downwardly from the plurality of openings, and
assuming a length of the skirt portion is L₂, a relationship 1×D≤L₂≤5×D is satisfied.

4. The method according to claim 1, wherein the plurality of openings is horseshoe-shaped, trapezoidal, rectangular, or triangular.

5. The method according to claim 1, wherein the processing target material further comprises a rod-shaped and/or plate-shaped processing target material, and the method further comprises, after the sieving, sieving the processing target material above the top of the vibrating sieve using a comb-tooth-shaped vibrating sieve comprising a plurality of slits.

6. The method according to claim 5, wherein an interval L₃ between the plurality of slits is 50 to 150 mm.

7. The method according to claim 1, wherein a raw material of the processing target material comprises automobile shredder dust, home appliance shredder dust, or electronic/electrical device part scraps.

8. The method according to claim 5, wherein the processing target material comprises stainless steel scraps and/or aluminum scraps, and the method comprises recovering the stainless steel scraps and/or the aluminum scraps by sieving using the comb-tooth-shaped vibrating sieve comprising the plurality of slits.

9. The method according to claim 1, wherein the processing target material is obtained by processing automobile shredder dust, home appliance shredder dust, and crushed electronic and electrical device parts scraps in a gasification and melting furnace to remove combustible components and then removing magnetic substances by magnetic separation.

10. The method according to claim 9, wherein the processing in the gasification and melting furnace is carried out under conditions of an air ratio of 1 or less and a temperature of 400 to 600° C.

11. The method according to claim 1, wherein the clump-shaped processing target material comprises a clump-shaped wire scraps formed by entanglement of wire scraps.

12. The method according to claim 1, wherein the clump-shaped processing target material comprises clump-shaped copper wire scraps formed by entanglement of copper wire scraps.

13. The method according to claim 9, wherein the combustible components comprise resins.
